(19) United States
(12) Patent Application Publication
(10) Pub. No.: US 2012/0073203 A1
(43) Pub. Date: Mar. 29, 2012

(54) SLIDING DOOR FOR AN ELEVATOR INSTALLATION

(76) Inventors: Peter Fasnacht, Dierikon (CH); Arnold Odermatt, Stans (CH); Bjarne Lindberg, Adligenswil (CH)

(21) Appl. No.: 13/248,669

(22) Filed: Sep. 29, 2011

(30) Foreign Application Priority Data
Sep. 29, 2010 (EP) 10181720.3

(51) Int. Cl. B66B 13/08

(52) U.S. Cl. 49/100; 49/506

(57) ABSTRACT

A sliding door for an elevator installation includes door leaves, which are horizontally displaceable between a closed position and an open position. The sliding door also includes a synchronization element, which is coupled with the door leaves and so synchronizes these that the door leaves are guided at different speeds, in an opening direction from the closed position to the open position or conversely opposite to the opening direction. The synchronization element includes at least one scissors linkage. The sliding door also includes a drive shaft coupled by way of a drive linkage at least with one door leaf. The sliding door additionally includes a locking mechanism which is so coupled with the drive shaft that the locking mechanism is openable by an actuation of the drive shaft when the door leaves are still substantially closed.

### CROSS-REFERENCE TO RELATED APPLICATION

This application claims priority to European Patent Application No. 10181720.3, filed Sep. 29, 2010, which is incorporated herein by reference.

### FIELD

The present disclosure relates to a sliding door for an elevator installation.

### BACKGROUND

Use is made in elevator installations of sliding doors not only as cage doors, but also shaft doors. Thus, EP 1 686 087 A1 describes a sliding door for use as a shaft door. This shaft door comprises several horizontally sliding door panels and a scissors linkage with several junction points, wherein the horizontally sliding door panels are synchronized by the scissors linkage. It is achieved by this synchronization that each door panel during an opening or closing process is set in motion at the same time and reaches its end position at the same time.

Sliding doors in elevator installations often have to be lockable. Thus, shaft doors shall not be able to be opened by passengers when no cage is disposed therebehind. Cage doors shall as a rule not be able to be opened by passengers when an elevator cage is not disposed at a storey. Triangular locks are often used for locking sliding doors. EP 1 727 763 B1 discloses a locking mechanism for keeping lobby doors locked, which mechanism comprises a hook which can be opened by entrainers of the elevator cage.

### SUMMARY

At least some embodiments of the disclosed technologies comprise a sliding door for an elevator installation, which can be securely locked. In some cases, the sliding door occupies little space.

Further embodiments comprise a sliding door with door leaves, a synchronization element, a drive shaft and a locking mechanism. In that case, the door leaves are horizontally displaceable between a closed position and an open position. The synchronization element is coupled with the door leaves and so synchronizes these that the door leaves are guided at different speeds, which are constant relative to one another, in an opening direction from the closed position to the open position and conversely opposite to the opening direction. The synchronization element comprises at least one scissors linkage. The drive shaft is coupled by way of a drive linkage at least with one door leaf. The locking mechanism is so coupled with the drive shaft that it is openable by actuation of the drive shaft when the door leaves are still substantially closed.

In some embodiments, when the door leaves are closed, the locking mechanism is not openable by a force, which acts on a door leaf in the opening direction thereof, without the drive shaft being actuated.

In further embodiments, the at least one scissors linkage is drivable by the drive shaft.

In additional embodiments, each door leaf is coupled with the scissors linkage to be rotatable about fulcra, wherein the scissors linkage comprises a free joint between each two fulcra.

In further embodiments, the synchronization element comprises four scissors linkages, wherein two scissors linkages are arranged in an upper region of the sliding door and wherein two further scissors linkages are arranged in a lower region of the sliding door. A first upper scissors linkage and a second upper scissors linkage are in that case possibly arranged in mirror image to one another, and a first lower scissors linkage and a second lower scissors linkage are similarly possibly arranged in mirror image to one another. The scissors linkages can be coupled together by the door leaves and/or by synchronization rods so that they execute an identical movement during opening or closing of the sliding door.

In further embodiments, the locking mechanism comprises a toggle mechanism. This toggle mechanism is coupled by a first limb with the drive shaft and drivable by the drive shaft. This toggle mechanism is rotatably coupled by a second limb with a door leaf.

In additional embodiments, the toggle mechanism is so designed that the first and second limbs are completely extended in the closed position of the door leaves. An abutment can be arranged so that the toggle mechanism in the case of over-extension of less than 10°, preferably less than 5°, is prevented from further over-extension.

In alternatives embodiments, the locking mechanism comprises a hook. This hook is rotatably arranged at the sliding door. By way of a translation linkage this hook can be rotated by actuation of the drive shaft and thereby opened and closed.

In further embodiments, the translation linkage comprises a lever which is rotatably arranged at a door leaf, possibly at a fastest door leaf.

In other embodiments, the lever is coupled with a toggle mechanism by way of a free joint. This toggle mechanism has two limbs, wherein one limb is coupled with a drive shaft and drivable by the drive shaft and wherein the second limb is coupled with the lever.

In additional embodiments, a door leaf, which is rotatably coupled with the lever, is coupled at least with one of the lower scissors linkage and a second toggle mechanism.

In still further embodiments, a sliding door comprises door leaves, which are horizontally displaceable between a closed position and an open position. The sliding door further comprises a synchronization element. The synchronization element can be coupled with the door leaves and can so synchronize these that the door leaves are guided at different speeds, which are constant relative to one another, in an opening direction from the closed position to the open position and conversely opposite to the opening direction. The synchronization element comprises at least one scissors linkage. The sliding door further comprises a drive shaft which is coupled by way of a drive linkage at least with one door leaf. The sliding door additionally comprises a locking mechanism, which is coupled with the drive shaft. The method comprises the step of opening the locking mechanism by actuation of the drive shaft when the door leaves are still substantially closed.

In some embodiments, during opening a hook, which is rotatably arranged at the sliding door, is rotated by way of a translation linkage by the actuation of the drive shaft and thereby opened or closed.

In other embodiments, during opening a toggle mechanism, which is coupled by a first limb with the drive shaft and is drivable by the drive shaft and which is rotatably coupled by a second limb with a door leaf, is guided from an over-extended state via a completely extended state into an angled state of the two limbs of the toggle mechanism.

In at least some embodiments, a sliding door can, through the use of door leaves in conjunction with a synchronization element, be designed to be space-saving. This can apply particularly when a width of the door leaves is kept as small as possible and a number of door leaves is correspondingly high. On the other hand, with some embodiments of the sliding door the locking mechanism is openable only by an actuation of the drive shaft. In a case of use as a shaft door, this can mean that the sliding door is openable not by an actuation of the door leaves in opening direction, but only by actuation of the drive shaft. The actuation of the drive shaft is usually achieved by an engagement between the cage door and the shaft door, wherein the cage door has a door drive.

In further embodiments, the sliding door does not have an additional lock. The locking mechanism is mechanically coupled with the drive shaft. The locking mechanism thereby does not involve electronic components susceptible to disturbance.

The synchronization element synchronizes the movement of the door leaves during opening and closing of the sliding door. The synchronization element can in that case be coupled with the drive shaft and thus transmit the drive force from the drive shaft to the door panel. Alternatively thereto, apart from the synchronization element a further drive linkage can be provided so that the further drive linkage transmits the force from the drive shaft to a door leaf and the synchronization element, which is similarly coupled with this door leaf, distributes the drive force appropriately to the other door leaves. Consequently, the synchronization element can serve solely for synchronization or, however, take over the function of the drive linkage and thus directly transmit the drive force from the drive shaft to the door leaves.

For scissors linkage, use can be made of individual scissors without crossing-over scissors elements or of double-scissors with crossing-over scissors elements. Pairs of scissors elements, i.e. two individual scissors or two double-scissors, can also be used or even combinations of individual scissors and double-scissors.

In some embodiments of the sliding door, the door leaves do not exert torque loading on a guide rail and thus there is no need for a guide carriage, but only a support roller. In addition, due to the low loads the support roller can be dimensioned to be small so that only a small constructional volume above the door leaves is demanded.

In further embodiments of the sliding door, through a suitable design of the synchronization elements a requisite stability of the sliding door during an entire opening phase and closing phase is maintained.

In additional embodiments of the sliding door, the door can be used for modernization of existing elevator installations. If, for example, shaft doors with rotatable door leaves are to be modernized, the sliding door can be mounted in simple mode and manner on existing door posts without a shaft door opening having to be enlarged or worked in another manner. In the case of modernization operations, work on masonry can be particularly undesirable, because dust and noise are thereby created.

The existing door posts can accordingly serve as a mounting basis. A coupling to an entrainer of a cage door can be produced by a drive shaft which is guided through the existing door posts.

In at least some modernization applications, using a mechanized, integrated locking mechanism can mean that very few couplings to or adaptations of existing residual components of the elevator installation have to be undertaken. A sliding door can thereby be installed in simple mode and manner as a finished unit with already integrated locking means.

### BRIEF DESCRIPTION OF THE DRAWINGS

Further details are described in the following on the basis of exemplifying embodiments and with reference to schematic drawings, in which:

FIG. 1A shows an exemplifying form of embodiment of a sliding door in perspective illustration;

FIG. 1B shows an exemplifying form of embodiment of a sliding door in sectional illustration;

FIG. 2A shows an exemplifying form of embodiment of a sliding door with a locking mechanism comprising a toggle mechanism in locked position;

FIG. 2B shows an exemplifying form of embodiment of a sliding door with a locking mechanism comprising a toggle mechanism in unlocked position;

FIG. 2C shows an exemplifying form of embodiment of a sliding door with a locking mechanism comprising a toggle mechanism in half-open position;

FIG. 2D shows an exemplifying form of embodiment of a sliding door with a locking mechanism comprising a toggle mechanism in opened position;

FIG. 3A shows an exemplifying form of embodiment of a locking mechanism comprising a toggle mechanism in locked position, in a perspective illustration;

FIG. 3B shows an exemplifying form of embodiment of a locking mechanism comprising a toggle mechanism in unlocked position, in a perspective illustration;

FIG. 3C shows an exemplifying form of embodiment of a locking mechanism comprising a toggle mechanism in half-open position, in a perspective illustration;

FIG. 3D shows an exemplifying form of embodiment of a locking mechanism comprising a toggle mechanism in opened position, in a perspective illustration;

FIG. 4A shows an exemplifying form of embodiment of a sliding door with a locking mechanism comprising a hook in locked position;

FIG. 4B shows an exemplifying form of embodiment of a sliding door with a locking mechanism comprising a hook in unlocked position;

FIG. 4C shows an exemplifying form of embodiment of a sliding door with a locking mechanism comprising a hook in half-open position;

FIG. 4D shows an exemplifying form of embodiment of a sliding door with a locking mechanism comprising a hook in opened position;

FIG. 5A shows an exemplifying form of embodiment of a locking mechanism comprising a hook in locked position, in perspective illustration;

FIG. 5B shows an exemplifying form of embodiment of a locking mechanism comprising a hook in unlocked position, in perspective illustration;

FIG. 5C shows an exemplifying form of embodiment of a locking mechanism comprising a hook in half-open position, in perspective illustration; and

FIG. 5D shows an exemplifying form of embodiment of a locking mechanism comprising a hook in opened position, in perspective illustration.

### DETAILED DESCRIPTION

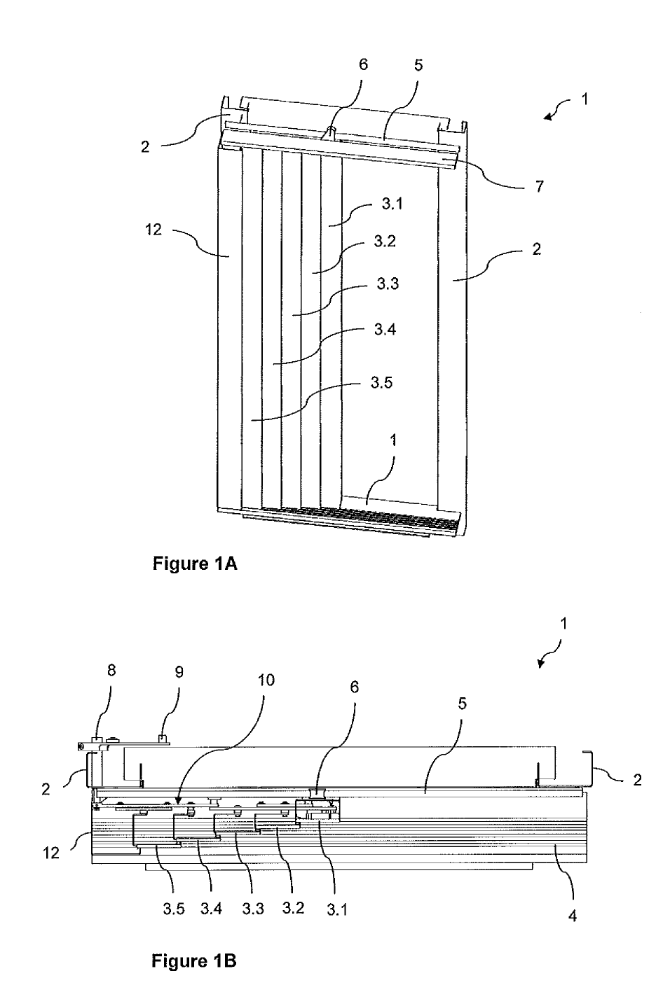

An exemplifying form of embodiment of a sliding door for an elevator installation is illustrated in FIGS. 1A and 1B. This sliding door is shown in perspective illustration in FIG. 1A and in sectional illustration in FIG. 1B. The sliding door 1 is arranged on a door frame 2. For the sake of better clarity only one door panel is illustrated. The door leaves 3.1, 3.2, 3.3, 3.4, 3.5 in that case form a door panel. The door leaves 3.1, 3.2, 3.3, 3.4, 3.5 are guided in a guide rail 4 disposed below the door leaves. A fastest door leaf 3.1 is suspended by way of a guide apparatus 6 at a guide rail 5. In that case a roller of the guide apparatus 6 runs on the guide rail 5. A lintel 7 closes off the door leaves 3.1, 3.2, 3.3, 3.4, 3.5 in upward direction.

The door leaves 3.1, 3.2, 3.3, 3.4, 3.5 are so designed that they can nest in one another and in a door post 12. In that case the fastest door leaf 3.1 is formed to be thinnest and a slowest door leaf 3.5 is formed to be thickest.

A synchronization element 10 synchronizes a movement of the door leaves 3.1, 3.2, 3.3, 3.4, 3.5 during opening and during closing of the sliding door. In that case the synchronization element 10 is coupled to a drive shaft 8. The drive shaft 8 extends through the door frame 2 and is in turn coupled to a drive engagement 9. In the case of use as a shaft door the sliding door 1 can thereby be driven by way of an entrainer (not illustrated) of a cage door.

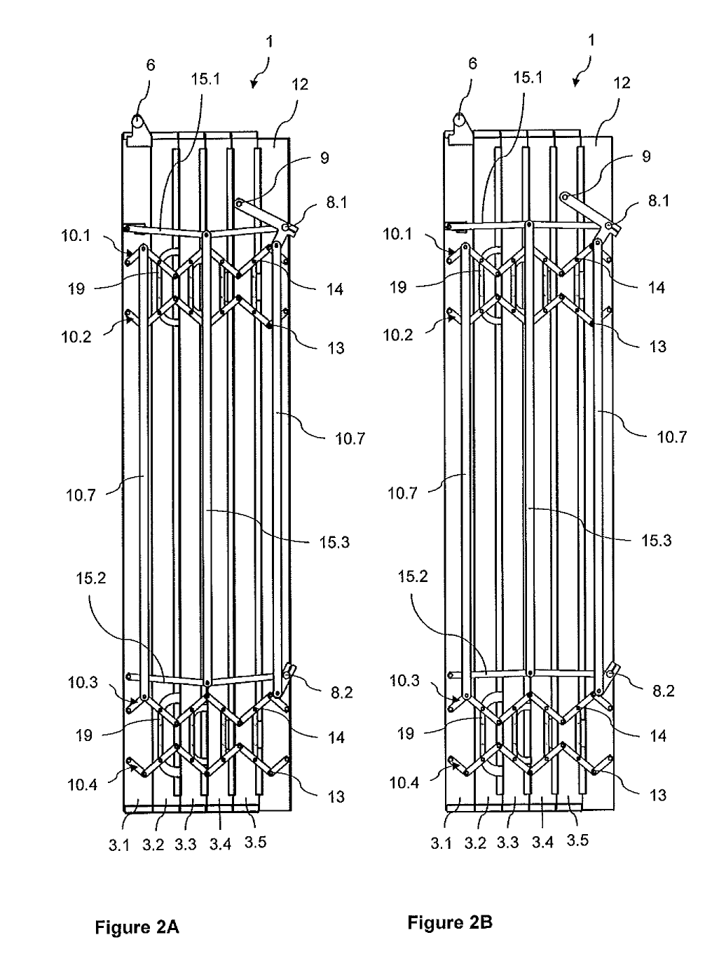

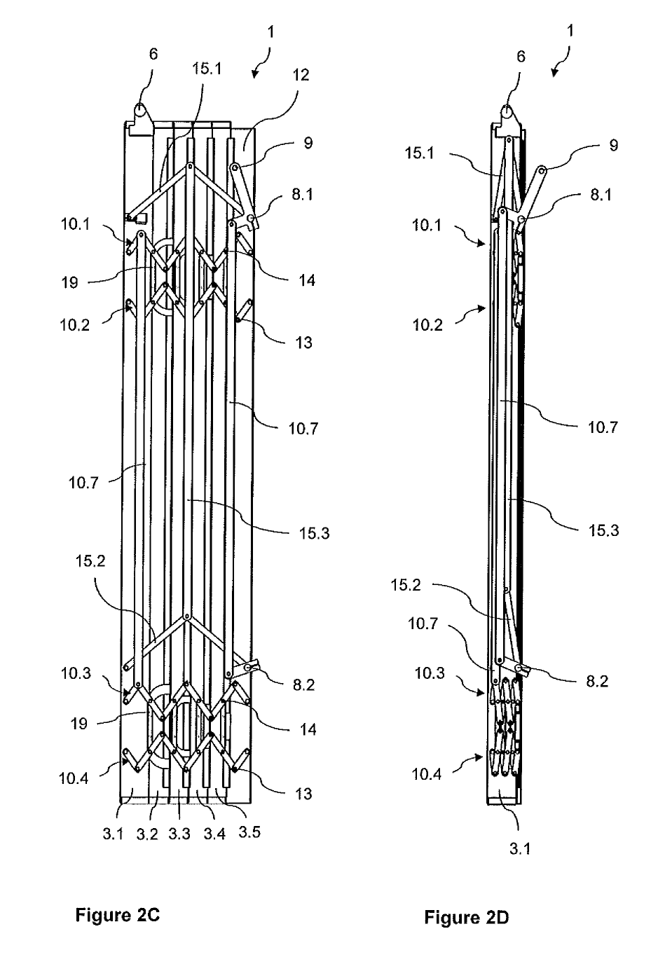

As illustrated in FIG. 1B the sliding door 1 can comprise a drive shaft 8. In an alternative form of embodiment the sliding door comprises an upper drive shaft 8.1 and a lower drive shaft 8.2, which are respectively coupled by upper and lower synchronization elements 10.1, 10.2, 10.3, 10.4. In FIGS. 2A to 5D in each instance only the upper drive shaft 8.1 is driven by way of the drive engagement 9. In an alternative form of embodiment (not illustrated) only the lower drive shaft 8.2 or the lower and the upper drive shafts 8.1, 8.2 is or are driven. In the following, to assist clarity, the term drive shaft 8 is used.

The sliding door 1 illustrated in FIGS. 1A and 1B is constructed as a centrally opening sliding door with five door leaves 3.1, 3.2, 3.3, 3.4, 3.5 per door panel. In an alternative form of embodiment a sliding door has only one door leaf and/or more or less than five door leaves per door panel.

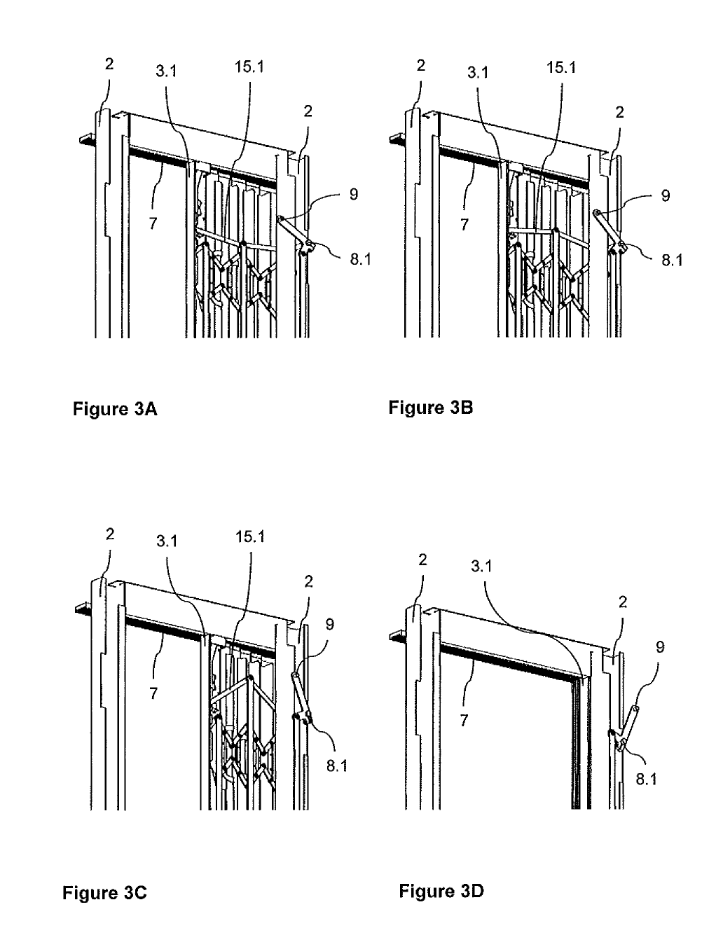

A sliding door 1 with a locking mechanism is illustrated in FIGS. 2A to 3D, wherein the locking mechanism comprises a toggle mechanism 15. In that case, FIGS. 2A to 2D each show an entire door leaf and FIGS. 3A to 3D each show a perspective illustration of a section of a sliding door 1 with a locking mechanism comprising a toggle mechanism 15. The locking mechanism with a toggle mechanism 15 is explained in more detail in the following on the basis of FIGS. 2A to 3D.

In this exemplifying embodiment the synchronization element 10 comprises four scissors linkages 10.1, 10.2, 10.3, 10.4. In that case, two upper scissors linkages 10.1 and 10.2 are arranged in an upper region of the sliding door 1 and two lower scissors linkages 10.3 and 10.4 are arranged in a lower region of the sliding door 1. A first upper scissors linkage 10.1 and a second upper scissors linkage 10.2 can then be arranged in mirror image to one another and a first lower scissors linkage 10.3 and a second lower scissors linkage 10.4 can be similarly arranged in mirror image to one another.

The scissors linkages 10.1, 10.2, 10.3, 10.4 are coupled together by the door leaves 3.1, 3.2, 3.3, 3.4, 3.5. Scissors linkages arranged in mirror image to one another thereby act like a double-scissors. In this arrangement, all four scissors linkages 10.1, 10.2, 10.3, 10.4 move synchronously with one another and impart enhanced stability to the sliding door 1.

In an alternative form of embodiment (not illustrated) the synchronization element 10 comprises one, two, three or more than four scissors linkages 10.1, 10.2, 10.3, 10.4. In that case, scissors linkages 10.1, 10.2, 10.3, 10.4 can be arranged at different heights. Use of scissors linkages 10.1, 10.2, 10.3, 10.4, which are arranged in mirror image to one another, at different heights improves the stability of the synchronization element 10.

The door leaves 3.1, 3.2, 3.3, 3.4, 3.5 are coupled with the scissors linkages 10.1, 10.2, 10.3, 10.4 by way of fulcra 14. In order to be able to gently transmit the forces which arise, reinforcing elements 19 can be provided at the door leaves 3.1, 3.2, 3.3, 3.4, 3.5. In this case the scissors linkages 10.1, 10.2, 10.3, 10.4 are coupled with the reinforcing elements 19, which are fixedly connected with the door leaves 3.1, 3.2, 3.3, 3.4, 3.5.

In the exemplifying embodiment shown in FIGS. 2A to 3D the toggle mechanism 15 serves for locking the sliding door 1. The toggle mechanism 15 has two limbs which are connected together by way of a joint. A first limb of the toggle mechanism 15 is coupled with the drive shaft 8 and drivable by this. A second limb of the toggle mechanism 15 is coupled with a door leaf 3.1, 3.2, 3.3, 3.4, 3.5, possibly the fastest door leaf 3.1. The toggle mechanism 15 is so dimensioned that the two limbs of the toggle mechanism 15 are fully extended when the sliding door 1 is closed.

The sliding door 1 is locked by an over-extension of the toggle mechanism 15. The toggle mechanism 15 is in that case possibly over-extended by only a few degrees so as to keep a thereby-caused opening of the sliding door as small as possible. In a possible form of embodiment an abutment is so arranged that the toggle mechanism 15 cannot be over-extended further than 10°, possibly not further than 5°. The abutment (not illustrated) can in that case be arranged at, for example, a door leaf 3.1, 3.2, 3.3, 3.4, 3.5. In an alternative form of embodiment the abutment is integrated in a joint of the toggle mechanism 15 so that the joint can be opened only as far as a desired opening angle.

The toggle mechanism 15 can be unlocked from the over-extended position by actuation of the drive shaft 8. Through actuation of the door leaves 3.1, 3.2, 3.3, 3.4, 3.5 in opening direction the toggle mechanism 15 can be moved out of the over-extended position, but not unlocked. An actuation of the drive shaft 8 can, for example, take place by displacement of the drive engagement 9. In that case, an entrainer, which is coupled with a drive of a cage door, typically engages in the drive engagement 9.

As illustrated in FIGS. 2A to 2D, a first toggle mechanism 15.1 and a second toggle mechanism 15.2 can be arranged. The first toggle mechanism 15.1 and the second toggle mechanism 15.2 are synchronized by way of a coupling rod 15.3. In this exemplifying embodiment only the first toggle mechanism 15.1 is drivable by the drive shaft 8.

An opening process is illustrated in FIGS. 2A to 3D. In that case, the locking mechanism comprising the toggle mechanism 15 in FIGS. 2A and 3A is disposed in a locked state and in FIGS. 2B and 3B in an unlocked state. In FIGS. 2C and 3C the sliding door is half-open and the toggle mechanism 15 is disposed in an angled state. In FIGS. 2D and 3D the sliding door is open. The drive engagement 9 is, during the opening process, displaced in clockwise direction about the drive shaft 8. An unlocking of the toggle mechanism 15 takes place with the door leaves 3.1, 3.2, 3.3, 3.4, 3.5 still substantially closed.

In FIGS. 2A to 2D the synchronization element 10 is coupled with the drive shaft 8. In an alternative form of embodiment, as illustrated in FIGS. 3A to 3D, the synchronization element 10 is not coupled with the drive shaft 8. In this exemplifying embodiment a force for opening the sliding door 1 is transmitted from the drive shaft 8 via the toggle mechanism 15 to the fastest door leaf 3.1 and from there distributed by the synchronization element 10 to the other door leaves 3.1, 3.2, 3.3, 3.4, 3.5. A decoupling of the toggle mechanism 15 and the synchronization element 10, such as is illustrated in FIGS. 3A to 3D, can mean that the synchronization element 10 is not directly driven by the drive shaft 8, and thereby the unlocking of the toggle mechanism 15 can take place more simply, because the door leaves 3.1, 3.2, 3.3, 3.4, 3.5 are set in motion with a certain degree of delay.

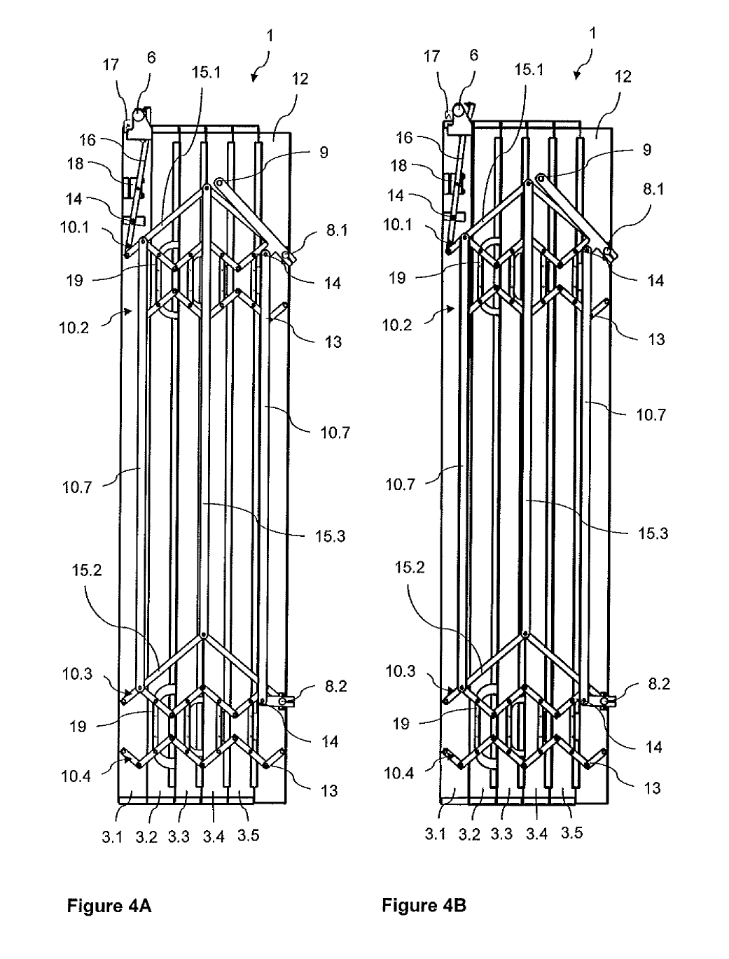

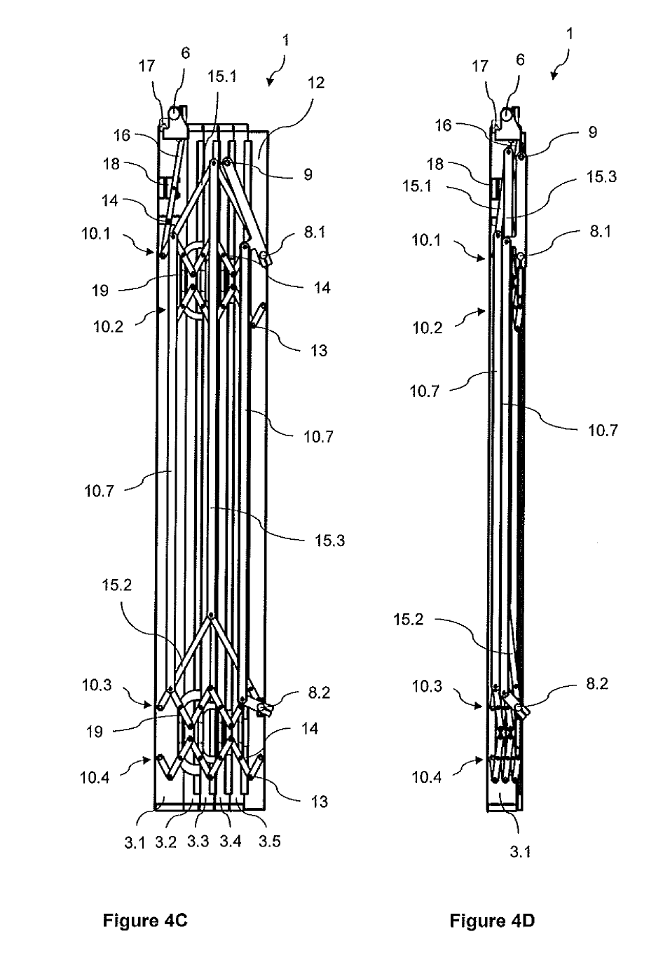

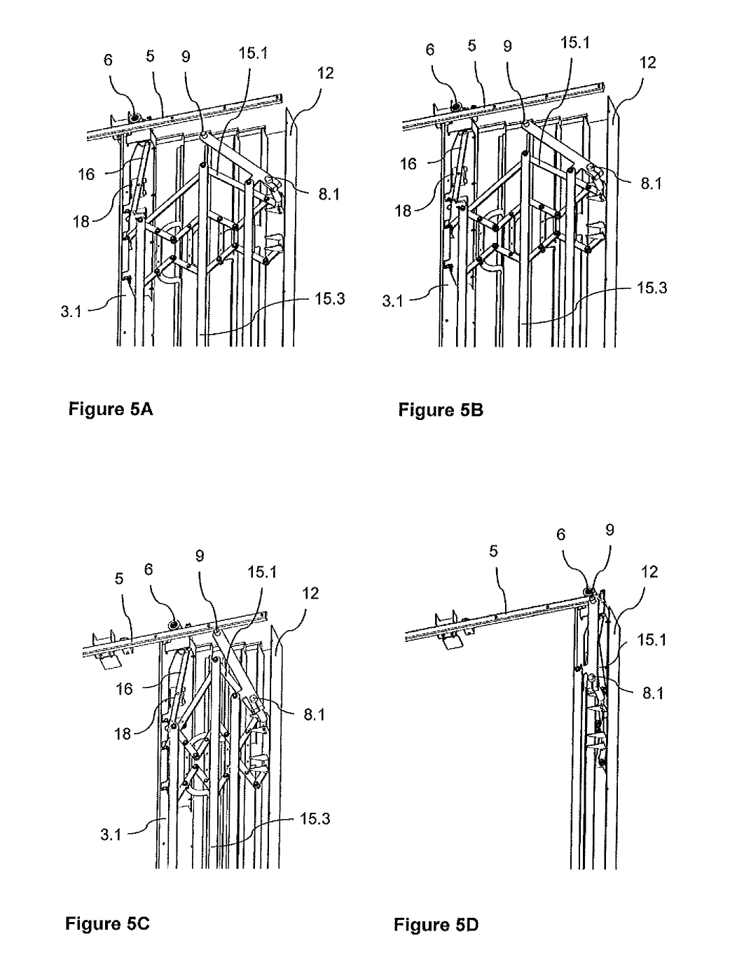

An alternative form of embodiment of a locking mechanism is illustrated FIGS. 4A to 5D. In this form of embodiment the locking mechanism comprises a hook 17. This hook 17 is arranged at a door leaf 3.1, 3.2, 3.3, 3.4, 3.5, preferably at the fastest door leaf 3.1. In that case the hook 17 is rotatably arranged at the door leaf 3.1, 3.2, 3.3, 3.4, 3.5. The hooks 17 can be rotated via a translation linkage 10, 15, 16 by actuation of the drive shaft 8 and thereby opened or closed. In a locked state the hook 17 engages in a lock engagement. In an open state the hook engagement is freed from the hook 17. The hook engagement is arranged to be immovable with respect to the door frame 2.

The translation linkage 10, 15, 16 serves for transmission of a rotary movement from the drive shaft 8 to the hook 17. In that case, the translation linkage 10, 15, 16 can be designed in various ways. In the exemplifying embodiment, such as is illustrated in FIGS. 4A to 5D, the translation linkage comprises a lever 16 and a toggle mechanism 15. The toggle mechanism 15 is then coupled at one end with the drive shaft 8 and at the other end by way of a free joint 13 with the lever 16. The lever 16 is rotatably connected with a door leaf 3.1, 3.2, 3.3, 3.4, 3.5. The toggle mechanism 15 is coupled with the synchronization element 10.

The locking mechanism is illustrated in a locked position in FIGS. 4A and 5A. The drive shaft 8 is actuated for unlocking the locking mechanism. After actuation of the drive shaft 8 the locking mechanism is unlocked, as illustrated in FIGS. 4B and 5B. The actuation of the drive shaft 8 has the consequence that an angle between the two limbs of the toggle mechanism 15 is reduced so that the free joint 13 of the toggle mechanism 15 is displaced in the direction of the drive shaft 8. Through this displacement of the free joint 13 the lever 16 is rotated counter-clockwise about a fulcrum 15. The hook 15 is rotated clockwise about its fulcrum by the rotation of the lever 16, so that the hook engagement is freed from the hook 17 and the locking mechanism is unlocked.

In the form of embodiment shown in FIGS. 4A to 5D, a first and a second upper scissors linkage 10.1 and 10.2 and a first and a second lower scissors linkage 10.3 and 10.4 are again provided. Similarly, a first toggle mechanism 15.1 and a second toggle mechanism 15.2 are arranged, wherein the first toggle mechanism 15.1 is coupled by way of a coupling rod 15.3 with the second toggle mechanism 15.2. The first and second upper scissors linkages 10.1, 10.2 and the upper toggle mechanism 15.1 are not coupled with the fastest door leaf 3.1. At least one of the lower scissors linkages 10.3, 10.4 and/or the second toggle mechanism 15.2 is or are coupled with the fastest door leaf 3.1. It is thereby made possible that in the case of unlocking of the locking mechanism a force is exerted at the fulcrum 14 on the fastest door leaf 3.1 in the direction of the drive shaft 8 so that the fastest door leaf 3.1 is, on unlocking, displaced into a slightly inclined setting. It is significant in that case that the hook 17 is unlocked before the door leaves 3.1, 3.2, 3.3, 3.4, 3.5 are substantially displaced in opening direction.

An opening process is illustrated in FIGS. 4A to 4D or 5A to 5D. In that case the locking mechanism comprising the hook 17 is disposed in FIGS. 4A and 5A in a locked state and in FIGS. 4B and 5B in an unlocked state. In FIGS. 4C and 5C the sliding door 1 is in a half-open state and in FIGS. 4D and 5D the sliding door 1 is open. The hook 17 can, after unlocking, be rotated back so that the hook 17, when the sliding door 1 is open, is disposed in the same position as when the sliding door 1 is unlocked.

During the opening process the drive engagement 9 is displaced clockwise about the drive shaft 8. An unlocking of the hook 17 takes place even with the door leaves 3.1, 3.2, 3.3, 3.4, 3.5 substantially closed.

A spring element 18, which is coupled with the lever 16, is illustrated in FIGS. 4A to 5D. The spring element 18 has the effect that the hook 17 after unlocking is rotated back so that the fastest door leaf 3.1 after its small inclined setting is brought back into a vertical alignment. In the case of the unlocking movement of the lever 16, springs in the spring element 18 are tensioned so that the lever 16 is, after the unlocking, brought back under spring loading into its original setting.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. A sliding door for an elevator installation, the sliding door comprising:
a plurality of door leaves, the door leaves being horizontally displaceable between a closed position and an open position;
a synchronization element coupled to the door leaves, the synchronization element being configured to guide the door leaves at different respective speeds between the closed position and the open position, the synchronization element comprising at least one scissors linkage;
a drive shaft;
a drive linkage, the drive shaft being coupled by the drive linkage to at least one of the plurality of door leaves; and
a locking mechanism, the locking mechanism being coupled with the drive shaft and openable by an actuation of the drive shaft when the plurality of door leaves is substantially closed.

2. The sliding door of claim 1, the locking mechanism being further openable by a force acting on one of the door leaves and without the drive shaft being actuated.

3. The sliding door of claim 1, the at least one scissors linkage being drivable by the drive shaft.

4. The sliding door of claim 1, the synchronization element comprising two upper scissors linkages and two lower scissors linkages, the two upper scissors linkages being arranged in mirror image to each other and the two lower scissors linkages being arranged in mirror image to each other.

5. The sliding door of claim 4, the two upper scissors linkages comprising first and second scissors linkages and the two lower scissors linkages comprising third and fourth scissors linkages, the first scissors linkage being drivable by the drive shaft, and the third scissors linkage being coupled to the first scissors linkage by one or more coupling rods.

6. The sliding door of claim 1, the synchronization element comprising first, second and third scissors linkages, the first scissors linkages being arranged in an upper region of the sliding door, the second scissors linkage being arranged in a lower region of the sliding door, and the third scissors linkage being arranged in mirror image to the first scissors linkage or the second scissors linkage.

7. The sliding door of claim 1, the at least one scissors linkage comprising a plurality of scissors linkages, each of the plurality of door leaves being rotatably coupled to a respective one of the plurality of scissors linkages at one or more fulcra, each of the scissors linkages comprising a respective free joint arranged between two fulcra.

8. The sliding door of claim 1, the locking mechanism comprising a hook, the hook being rotatable by a translation linkage through actuation of the drive shaft.

9. The sliding door of claim 8, the hook being configured to engage a hook engagement, the hook engagement being coupled to a door frame.

10. The sliding door of claim 8, the translation linkage comprising a lever rotatably arranged at one of the plurality of door leaves.

11. The sliding door of claim 10, the lever being rotatably arranged at a fastest one of the plurality of door leaves.

12. The sliding door of claim 10, the lever being coupled with a toggle mechanism, the toggle mechanism having first and second limbs, the first limb being coupled with the drive shaft and the second limb being coupled with the lever.

13. The sliding door of claim 12, the toggle mechanism being further coupled with the synchronization element.

14. A method for a sliding door of an elevator installation, the method comprising:
opening a locking mechanism of the sliding door by actuating a drive shaft, the sliding door comprising a plurality of door leaves, the door leaves being horizontally displaceable between a closed position and an open position, the opening of the locking mechanism being performed while the plurality of door leaves are substantially in the closed position; and
guiding the plurality of door leaves into the open position using a synchronization element coupled to the door leaves, the synchronization element being configured to guide the door leaves at different respective speeds between the closed position and the open position, the synchronization element comprising at least one scissors linkage.

15. The method of claim 14, the opening the locking mechanism further comprising rotating a hook using a translation linkage coupled to the drive shaft.

16. A sliding door for an elevator installation, the sliding door comprising door leaves which are horizontally displaceable between a closed position and an open position, and a synchronization element, which is coupled with the door leaves and so synchronizes these that the door leaves are guided at different speeds, which are constant relative to one another, in an opening direction from the closed position to the open position and conversely opposite to the opening direction, wherein the synchronization element comprises at least one scissors linkage, wherein a drive shaft is coupled by way of a drive linkage at least with one door leaf, and wherein a locking mechanism is so coupled with the drive shaft that the locking mechanism is openable by an actuation of the drive shaft when the door leaves are still substantially closed.
